(19) United States
(12) Patent Application Publication
(10) Pub. No.: US 2010/0215823 A1
(43) Pub. Date: Aug. 26, 2010

(54) FROZEN MINCED FISH PRODUCT

(76) Inventor: Won Byong Yoon, Chuncheon-si (KR)

Correspondence Address: WINSTON & STRAWN LLP;PATENT DEPARTMENT, 1700 K STREET, N.W., WASHINGTON, DC, 20006, US

(21) Appl. No.: 12/602,889

(22) PCT Filed: May 29, 2008
(86) PCT No.: PCT/IB08/52097

§ 371 Date: Dec. 3, 2009

(30) Foreign Application Priority Data
Jun. 14, 2007 (IB) PCT/IB07/52253

(51) Int. Cl. A23L 1/226; A23L 1/325

(52) U.S. Cl. 426/536; 426/643; 426/442

(57) ABSTRACT

A frozen minced-fish base that includes, as an additive for inhibiting off-notes, a compound according to formula (I) or formula (II):

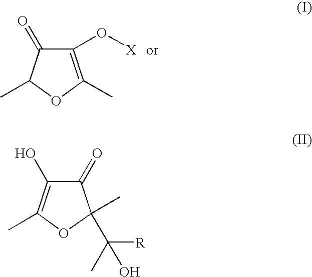

wherein X designates a linear or branched, saturated or unsaturated C₁-C₅ hydrocarbon radical or a group of formula

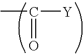

wherein Y designates a linear or branched, saturated or unsaturated C₁-C₆ hydrocarbon radical, and R represents a hydrogen atom, a methyl group, an acetyl group or an ethoxycarbonyl group.

### TECHNICAL FIELD

The present invention relates to a frozen minced fish product having reduced off-notes and to a method of producing a frozen minced fish product.

### BACKGROUND AND PRIOR ART

Conventionally, frozen minced fish (referred to as “frozen surimi”) has been produced by a process in which minced fish meat obtained from a fish, such as pollack, is to firstly subjected to two or more washes with fresh water, with the addition of a small amount of common salt during the last wash step. This is followed by removal of the skin where necessary, dehydration by a screw-press, and mixing of the resulting product with the addition of sugars, sugar alcohols, polyphosphates, and the like. Finally the product is packed and stored under refrigeration at −20° C. to −40° C.

The frozen surimi can then be thawed and processed to a variety of surimi-based products such as kamaboko, chikuwa, surimi sticks, chunks, dice, rolls and nuggets and the like.

In order to catch the fish, the trawler must often travel long distances due to restrictions imposed on fishing quotas and so the period between the catch and landing the fish can be up to a month or longer. As a result, the commercial value of surimi markedly decreases because of loss of freshness and potentially strong off-notes which develop during storage. Where the smell is especially strong, the utility for surimi-based products becomes very limited.

It is known to deodorize frozen surimi base by adding, for instance, cyclodextrin prior to the freezing step. The cyclodextrin forms a clathrate entrapping the flavours that generate the off-notes. However, cyclodextrin also traps other flavours, which improve the taste of the surimi and so its utility is limited. Another example of deodorizing frozen surimi is given in U.S. Pat. No. 4,910,039 (Fujita et al), which discloses an additive for this purpose comprising branched dextrins together with reduced dextrins and a surfactant. The branched dextrin is a large compound having a molecular weight above 3000 since, it is stated, below this weight the control of odour is ineffective. Such systems are complicated to handle due to the large mixture of different compounds and polymers present and also due to the need to separate out, via complicated processing, dextrins which do not serve the purpose.

The present invention seeks to address one or more of the above-mentioned problems and/or to provide one or more of the abovementioned benefits.

A particularly preferred object of the present invention is to provide a simple additive for masking the off-notes in frozen surimi base without masking desirable notes.

### SUMMARY OF THE INVENTION

Accordingly, the present invention provides the use of a compound according to formula (I) and/or formula (II):

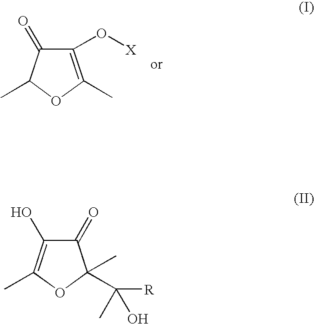

wherein X designates a linear or branched, saturated or unsaturated C₁-C₅ hydrocarbon radical or a group of formula

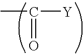

wherein Y designates a linear or branched, saturated or unsaturated C₁-C₆ hydrocarbon radical, and R represents a hydrogen atom, a methyl group, an acetyl group or an ethoxycarbonyl group,
to deodorise and/or mask the off-notes in frozen minced-fish base.

The invention also provides a method of preparing a frozen minced-fish base comprising the steps:

(a) mincing the fish,

(b) washing the minced fish,

(c) optionally mixing the washed fish,

(d) adding to the washed fish a compound according formula (I) and/or formula (II):

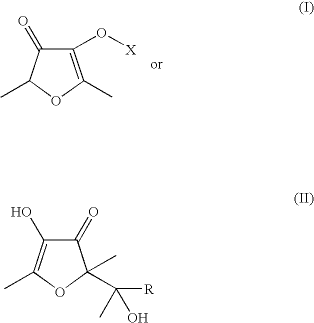

wherein X designates a linear or branched, saturated or unsaturated C₁-C₅ hydrocarbon radical or a group of formula

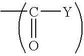

wherein Y designates a linear or branched, saturated or unsaturated C₁-C₆ hydrocarbon radical, and R represents a hydrogen atom, a methyl group, an acetyl group or an ethoxycarbonyl group, and

(e) freezing the resulting mixture.

In another aspect, the invention provides a frozen minced-fish base comprising, as an additive for inhibiting off-notes, a compound according formula (I) and/or formula (II):

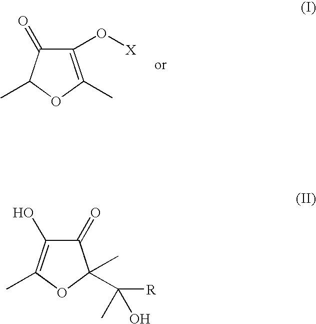

wherein X designates a linear or branched, saturated or unsaturated C₁-C₅ hydrocarbon radical or a group of formula

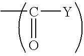

wherein Y designates a linear or branched, saturated or unsaturated C₁-C₆ hydrocarbon radical, and R represents a hydrogen atom, a methyl group, an acetyl group or an ethoxycarbonyl group.

### DETAILED DESCRIPTION OF THE INVENTION

The present invention is directed to improving the flavour of frozen surimi by masking the off-notes that can accompany the product. The off-note masking agent comprises a compound according formula (I) and/or formula (II):

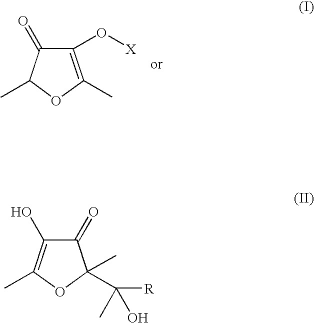

wherein X designates a linear or branched, saturated or unsaturated C₁-C₅ hydrocarbon radical or a group of formula

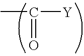

wherein Y designates a linear or branched, saturated or unsaturated C₁-C₆ hydrocarbon radical, and R represents a hydrogen atom, a methyl group, an acetyl group or an ethoxycarbonyl group.

Of the compounds having this formula, it is particularly preferred that the compound is selected from one or more of 3-hydroxy-4,5-dimethyl-2(5H)-furanone, 4-hydroxy-2,5-dimethyl-3(2H)-furanone, 4-hydroxy-5-methyl-3(2H)-furanone, 3-hydroxy-2-methyl-4(4H)-pyranone, 3-hydroxy-2-ethyl-4(4H)-pyranone, 2-hydroxy-2-penten-4-olide and 4-hydroxy-2,5-dimethyl-3(2H)-furanone. It is particularly preferred that the off-taste masking agent is 4-hydroxy-2,5-dimethyl-3(2H)-furanone. This is an ingredient, currently sold under the tradename of Furaneol® (origin; Firmenich S A, Geneva).

All of the above-mentioned ingredients have molecular weights significantly below the molecular weights of the branched dextrins disclosed in U.S. Pat. No. 4,910,039. Furthermore, the active ingredient(s) in the present invention do not require complicated polymeric mixtures of different types of ingredients.

The frozen minced fish product in which the active odour-masking component is to present is typically known as frozen-surimi. The term “surimi” is, moreover, a generic name for various fish-based products. For instance, the following fish are well known as “surimi”; Alaska pollack, Atka mackerel, Sardines, Mackerel, Pacific sauries, Cutlassfish, Sea eels, walleye pollack, Pacific herring, pike eel, righteye flounder, jack mackerel, melulusa Flatfish, Horse mackerel, merlu or mixtures thereof. This list is merely exemplary and is, in no way, exhaustive.

Thus, the applicability of the present invention is not restricted to the above-described types of fish but includes all fish or other sea- or fresh water-creatures which are capable of being processed into surimi.

The off-note masking component is present in an amount of from 0.0015% to 0.25% by weight based on the total weight of the frozen minced fish (surimi) composition. More preferably, the off-note masking component is present in an amount of from 0.002% to 0.2% by weight, even more preferably from 0.005 to 0.15, most preferably from 0.007 to 0.12%.

It is especially surprising that such low levels of off-note masking component can effectively reduce off-odours in the minced fish product since, the prior art, as set out in U.S. Pat. No. 4,910,039 teaches that much higher levels are required. In particular this document refers to a requirement of 0.5 wt % or more of branched dextrin, based on the weight of fish meat, more preferably about 1 to 3 wt %.

In the process according to the present invention, the off-note masking component is introduced after the washing step but prior to the freezing step. This is found to be essential because the effect of the off-note masking component, is very significantly improved, compared to when the agent is added at any other stage of the processing. Moreover, this effect is particularly pronounced when the off-note masking agent is used at the very low levels, described above.

Various optional ingredients can be added to the surimi during processing. For instance, surfactants such as glycerol fatty acid esters, sucrose fatty acid esters, sorbitan fatty acid esters, propylene glycol fatty acid esters, polyglycerol fatty acid esters, lecithin, polyoxyethylene sorbitan fatty acid esters and their mixtures can be added so as to improve the whiteness and/or elasticity of the frozen-surimi product.

The surfactant for food used as the additive for surimi of this invention is preferably mixed with the fish meat at a ratio of 0.1-1.0% by weight, especially 0.1-0.5% to by weight. The surfactant for food may be used alone or as a mixture with fats and oil. It is preferred that the total amount of surfactant for food and the fats and oil is in the above range when fats and oil are used. The surfactant is preferably dispersed in a sugar or sugar alcohol. Suitable sugars include glucose, maltose, sucrose, lactose, maltitol, sorbitol and the like.

Additionally, other improving agents, for example, a freezing denaturation preventing agent (e.g. polyphosphate, sorbitol, sugar, whey protein concentrate, starch and so on) and an elasticity improving agent (e.g. gluten, soybean protein, egg protein, milk protein or blood plasma) may be added.

Organic acid salts may also be added to improve elasticity of the frozen surimi base. Examples include sodium citrate, calcium citrate, sodium acetate, calcium acetate, sodium tartrate, calcium tartrate and sodium gluconate. The most preferable include sodium citrate and/or sodium gluconate.

Organic acid salts are preferably added in a quantity of 0.1-0.5% by weight, preferably within the range of 0.1-0.2% by weight based on the total weight of the surimi-base.

It has been found that by adding the organic acid salts into the frozen minced fish base, the desired elasticity of the frozen surimi base can be maintained.

Sodium chloride, if used, is preferably present in an amount of from 0.6-1% by weight, based on the total weight of frozen-fish base. If more than 1% is added in, it is found to adversely affect the elasticity of the product.

The invention will now be described with reference to the following examples. It is to be understood that the examples are illustrative of the invention and that the scope of the invention is not limited thereto.

### EXAMPLES

All amounts are % by weight unless otherwise indicated.

### Example 1

### Preparation of a Salt-Water Minced Fish Product

Fresh Alaska Pollacks (Theragra chalcogram) was filleted and passed through a standard belt-type drum having holes of 5 mm diameter in order to mince, and partially dewater the to fish. The minced fish was then washed by stirring in a container of fresh water for 15 minutes at a temperature of 5° C. to remove water-soluble matter. This step was repeated a second time in a container of slightly brackish water. The washed fish was refined to remove skin and then dewatered using a screw press to provide a minced-fish having a moisture content of around 80 to 90%. Standard cryoprotective agents were added at a level of 2 wt %. The mixture was then divided into two samples. The first sample was rapidly frozen to minus 20° C. To the second sample, prior to freezing, Furaneol® (ex Firmenich) was admixed at a level of 0.07%. The second sample was then rapidly frozen to minus 20° C. Rapid freezing was performed using standard air-blast freezing techniques.

The samples were stored for 1 week and then defrosted to a temperature of 20° C.

The first sample quickly generated undesirable off-notes whereas the second sample was found to be substantially free of the off-notes.

### Example 2

### Preparation of a Fresh-Water Minced Fish Product According to the Invention

The method according to example 1 was repeated exactly except that grass carp Ctenopharyngodon idella) was used instead of Alaska Pollacks.

The frozen samples were again allowed to thaw to a temperature of 20° C. Sample 1 quickly generated a “muddy” odour upon standing whereas sample 2 was found to maintain its fresh-fish odour without the significant off-notes.

1-6. (canceled)

7. A frozen minced-fish base comprising, as an additive for inhibiting off-notes, a compound according to formula (I), formula (II) or both 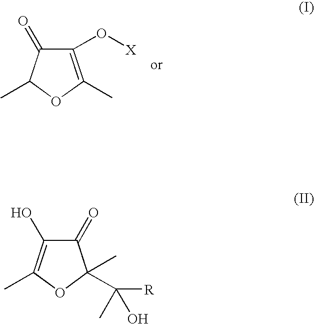
wherein X designates a linear or branched, saturated or unsaturated C₁-C₅ hydrocarbon radical or a group of formula 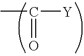
wherein Y designates a linear or branched, saturated or unsaturated C₁-C₆ hydrocarbon radical, and R represents a hydrogen atom, a methyl group, an acetyl group or an ethoxycarbonyl group.

8. The frozen minced-fish base of claim 7, wherein the additive is present in an amount of from 0.0015% to 0.25 wt %.

9. The frozen minced-fish base of claim 7, wherein the additive is selected from the group consisting of 3-hydroxy-4,5-dimethyl-2(5H)-furanone, 4-hydroxy-2,5-dimethyl-3(2H)-furanone, 4-hydroxy-5-methyl-3(2H)-furanone, 3-hydroxy-2-methyl-4(4H)-pyranone, 3-hydroxy-2-ethyl-4(4H)-pyranone, 2-hydroxy-2-penten-4-olide and 4-hydroxy-2,5-dimethyl-3(2H)-furanone.

10. The frozen minced-fish base of claim 7, wherein the additive is 4-hydroxy-2,5-dimethyl-3(2H)-furanone.

11. The frozen minced-fish base of claim 8, wherein the additive is 4-hydroxy-2,5-dimethyl-3(2H)-furanone.

12. A method for deodorising or masking off-notes in a frozen minced-fish base, which comprises adding to the base a compound according to formula (I), formula (II), or both: 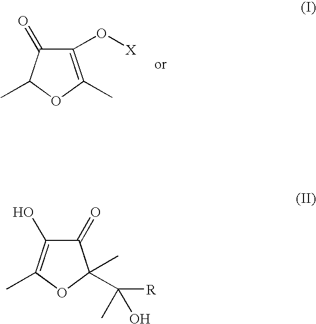
wherein X designates a linear or branched, saturated or unsaturated C₁-C₅ hydrocarbon radical or a group of formula 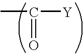
wherein Y designates a linear or branched, saturated or unsaturated C₁-C₆ hydrocarbon radical, and R represents a hydrogen atom, a methyl group, an acetyl group or an ethoxycarbonyl group, wherein the compound is added in an effective amount to achieve the deodorizing or masking of the off notes.

13. A method of preparing a frozen minced-fish base comprising the steps:
mincing the fish,
washing the minced fish,
adding to the washed fish a compound according to formula (I), formula (II), or both: 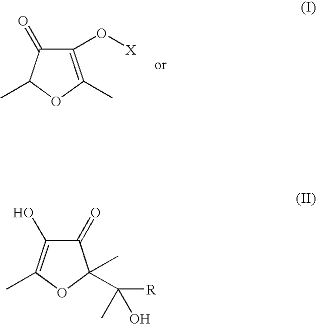
wherein X designates a linear or branched, saturated or unsaturated C₁-C₅ hydrocarbon radical or a group of formula 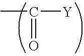
wherein Y designates a linear or branched, saturated or unsaturated C₁-C₆ hydrocarbon radical, and R represents a hydrogen atom, a methyl group, an acetyl group or an ethoxycarbonyl group, and
freezing the resulting mixture.

14. The method of claim 13, wherein the compound is added in an amount effective to deodorize or mask off notes of the washed fish.

15. The method of claim 13, which further comprises optionally mixing the washed fish with other edible components prior to freezing.
